(19) United States
(12) Patent Application Publication
(10) Pub. No.: US 2025/0270237 A1
(43) Pub. Date: Aug. 28, 2025

(54) PREPARATION OF AMINE-BORANES UTILIZING AN ACTIVATOR

(71) Applicant: Purdue Research Foundation, West Lafayette, IN (US)

(72) Inventors: Padinjaremadhom V. Ramachandran, West Lafayette, IN (US); Henry John Hamann, West Lafayette, IN (US)

(21) Appl. No.: 19/032,690

(22) Filed: Jan. 21, 2025

Related U.S. Application Data
(60) Provisional application No. 63/556,932, filed on Feb. 23, 2024.

(51) Int. Cl. C07F 5/02

(52) U.S. Cl. CPC C07F 5/027

(57) ABSTRACT

A process for preparing amine-boranes from sodium borohydride and corresponding amines using an activator selected from an aldehyde, a ketone, an alcohol, an organic acid, a sulfonic, and water in the presence of a green solvent, such as ethyl acetate.

### CROSS-REFERENCE TO RELATED APPLICATIONS

This application claims priority to U.S. provisional patent application No. 63/556,932 which was filed Feb. 23, 2024, and which is hereby incorporated by reference in its entirety.

### TECHNICAL FIELD

The present disclosure relates to a process for preparing amine-boranes from sodium borohydride and corresponding amines using an activator in the presence of a green solvent.

### BACKGROUND

This section introduces aspects that may help facilitate a better understanding of the disclosure. Accordingly, these statements are to be read in this light and are not to be construed as admissions about what is or is not prior art.

Amine-boranes are extremely important reagents for a variety of organic reactions. For example, they are applicable as reagents for reduction, hydroboration, reductive amination, and transfer hydrogenation reactions. Accordingly, their synthesis has received considerable attention from organic chemists, and there are several procedures available in the literature. The original synthesis of amine-borane involved treating diborane gas with carbon monoxide gas to form a borine-carbonyl intermediate. This intermediate was treated with trimethylamine to yield trimethylamine-borane (Burg et al., Journal of American Chemical Society, 1937, 59, 780-787).

Modern-day preparations of amine-boranes have evolved since their initial preparation. These updated protocols for amine-borane synthesis utilize adducts of borane coordinated to electron pair-donating Lewis basic molecules, such as dimethyl sulfide or tetrahydrofuran (Kelly et al., Journal of American Chemical Society, 1960, 82, 4842-4846). Another type of amine-borane preparation involves the salt metathesis reaction, wherein the reagents react to form a protonated amine salt, which undergoes a metathesis exchange with the present sodium borohydride (NaBH₄) to form a new salt of the protonated amine with borohydride. This new salt then spontaneously liberates an equivalent of hydrogen gas to form the product amine-borane (Ramachandran, P. V. et al., Inorganic Chemistry, 2015, 54, 12, 5618-5620).

Recently, a protocol for the synthesis of amine-boranes using NaBH₄, sodium bicarbonate (NaHCO₃), water, and the chosen amine has been reported (Ramachandran, P. V. et al., Chemical Communication, 2016, 52, 11885-11888). The above reaction is proposed to proceed via salt metathesis between NaBH₄ and ammonium carbonate formed by deprotonation of carbonic acid by the amine. On this basis, it was anticipated that carbonic acid formed from water and carbon dioxide (CO₂) would suitably replace NaHCO₃(Ramachandran, P. V. et al., Dalton Transaction, 2021, 50, 16770-16774). A related synthesis involving the activation of NaBH₄ uses benzoic acid, which reacts with sodium borohydride to form a monobenzoyloxyborohydride intermediate. The amine reacts with this intermediate, displacing the acyloxy ligand by coordination of the amine, forming the amine-borane product (Kawase, Y. et al., Org. Process Res. Dev. 2012, 16, 495-498). All of the previously reported procedures suffer from one or more serious disadvantages, including, hazardous reagent preparation, the use of toxic, unstable, or expensive reagents and solvents, the generation of undesirable by-products, or poor atom economy.

Hence, there is a need for a safe, more environmentally friendly, and economical process for synthesizing amine-boranes. It is an object of the present disclosure to provide such a process. This and other objects and advantages, as well as inventive features, will be apparent from the detailed description.

### SUMMARY

Provided is a process for preparing amine-boranes, which process comprises reacting an amine with a sodium borohydride using an activator in the presence of a solvent.

In some embodiments, an amine-borane formed in the process is of formula (I):

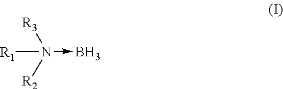

wherein each R₁, R₂, and R₃ is independently selected from hydrogen, alkyl, cycloalkyl, heteroalkyl, heterocycloalkyl, aryl, heteroaryl, alkylaryl, and arylalkyl, wherein each R₁, R₂, and R₃ is optionally independently substituted with at least one of halo, OH, OR₄, CONR₄R₅, SO₂R₄, alkyl, cycloalkyl, heteroalkyl, heterocycloalkyl, aryl, heteroaryl, alkylaryl, and arylalkyl; or
R₁ and R₂, together with the nitrogen atom to which they are attached, form a 4- to 8-membered heterocyclic ring, wherein the heterocyclic ring is a substituted or an unsubstituted ring, which optionally contains an oxygen atom; or R₁ and R₃, together with the nitrogen atom to which they are attached, form a 4- to 8-membered heterocyclic ring, wherein the heterocyclic ring is a substituted or an unsubstituted ring, which optionally contains an oxygen atom; or R₁, R₂, and R₃, together with the nitrogen atom to which they are attached, form a 4- to 8-membered heteroaromatic ring, wherein the heteroaromatic ring is a substituted or unsubstituted ring, which optionally contains an oxygen atom; and
each R₄ and R₅ is independently alkyl or aryl.

In some embodiments, an amine used in the process is of formula (II):

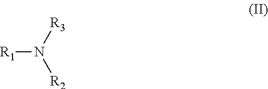

wherein each R₁, R₂, and R₃ is independently selected from hydrogen, alkyl, cycloalkyl, heteroalkyl, heterocycloalkyl, aryl, heteroaryl, alkylaryl, and arylalkyl, wherein each R₁, R₂, and R₃ is optionally independently substituted with at least one of halo, OH, OR₄, CONR₄R₅, SO₂R₄, alkyl, cycloalkyl, heteroalkyl, heterocycloalkyl, aryl, heteroaryl, alkylaryl, and arylalkyl; or
R₁ and R₂, together with the nitrogen atom to which they are attached, form a 4- to 8-membered heterocyclic ring, wherein the heterocyclic ring is a substituted or an unsubstituted ring, which optionally contains an oxygen atom; or R₁ and R₃, together with the nitrogen atom to which they are attached, form a 4- to 8-membered heterocyclic ring, wherein the heterocyclic ring is a substituted or an unsubstituted ring, which optionally contains an oxygen atom; or R₁, R₂, and R₃, together with the nitrogen atom to which they are attached, form a 4- to 8-membered heteroaromatic ring, wherein the heteroaromatic ring is a substituted or unsubstituted ring, which optionally contains an oxygen atom; and
each R₄ and R₅ is independently alkyl or aryl.

In some embodiments, an amine is selected from ammonia (NH₃), methyl amine (NH₂Me), benzylamine (NH₂CH₂Ph), dimethyl amine (NHMe₂), isopropyl amine (NH (i-Pr)₂), trimethyl amine (NMe₃), triethyl amine (NEt₃), piperidine, and cyclohexylamine. In some embodiments, the amine is pyridine, wherein the pyridine is optionally substituted with at least one of alkyl amine and dialkyl amine. In some embodiments, the substituted pyridine is 4-dimethylaminopyridine, 5-ethyl-2-methylpyridine, or 2-picoline.

The solvent used can be selected from ethyl acetate, propyl acetate, butyl acetate, ethanol, 2-propanol, aqueous sodium hydroxide, acetone, acetonitrile, and dimethyl sulfoxide. In some embodiments, the desired solvent is ethyl acetate, propyl acetate, or butyl acetate.

An activator that can be used is selected from an aldehyde of formula R₄—CHO, a ketone of formula R₄—CO—R₅, an alcohol of formula R₄—OH, an organic acid of formula R₄—COOH, a sulfonic acid of formula R₄—SO₃H, and water, wherein each R₄ and R₅ is independently alkyl or aryl. In some embodiments, the activator is selected from acetaldehyde, propanal, acetone, diethyl ketone, ethyl methyl ketone, methanol, ethanol, butanol, phenol, methane sulfonic acid, trifluoromethane sulfonic acid, benzene sulfonic acid, toluene sulfonic acid, formic acid, acetic acid, trifluoroacetic acid, and benzoic acid. In some embodiments, the desired activator is water.

In some embodiments, the reaction is carried out at a concentration of the amine in the solvent of about 0.1 M to about 3 M. In some embodiments, the concentration of the amine-borane complexes is between about 0.05 mol/L to about 10 mol/L. The reaction can be carried out at a temperature from about 0° C. to about 60° C.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the claimed invention is thereby intended.

As used herein, the following terms and phrases shall have the meanings set forth below. Unless defined otherwise, all technical and scientific terms used herein have the same meaning as commonly understood to one of ordinary skill in the art.

The “arrow” in a amine-borane represents the coordinate covalent bond between nitrogen from N R₁R₂R₃ and boron.

Abbreviations used are:
NH₂Me—methylamine, NH₂tBu—tert-butylamine, NHMe₂—dimethylamine, NMe₃—trimethylamine, NH₂CH₂Ph- benzyl amine, NH (i-Pr)₂—isopropyl amine, NEt₃—triethylamine, and tert-tertiary.

Amine-boranes are important reagents used in organic and materials chemistry. They are commonly used as energy materials. However, they are expensive due to the cost of their preparation. The reported processes involve using toxic, expensive, and unstable reagents and solvents, which are difficult to handle for large-scale processes. Scaling up a chemical reaction can be complex, and processes must be determined to have low sensitivity to variations in the materials and conditions used in scaled reactions to be deemed robust. Therefore, there is a need for an economical and environmentally friendly process suitable for large scale.

In view of the above, provided is a process for preparing amine-boranes using sodium borohydride (NaBH₄) with water as an activator and ethyl acetate as a solvent. The process avoids using the traditional solvent tetrahydrofuran and uses green materials, such as water and ethyl acetate, with NaBH₄ as a borane source, which makes the process economical and environmentally friendly for large-scale production.

Provided is the process for preparing an amine-borane of formula (I):

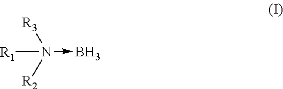

wherein each R₁, R₂, and R₃ is independently selected from hydrogen, alkyl, cycloalkyl, heteroalkyl, heterocycloalkyl, aryl, heteroaryl, alkylaryl, and arylalkyl, wherein each R₁, R₂, and R₃ is an optionally independently substituted with at least one of halo, OH, OR₄, CONR₄R₅, SO₂R₄, alkyl, cycloalkyl, heteroalkyl, heterocycloalkyl, aryl, heteroaryl, alkylaryl, and arylalkyl; or
R₁ and R₂, together with the nitrogen atom to which they are attached, form a 4- to 8-membered heterocyclic ring, wherein the heterocyclic ring is a substituted or an unsubstituted ring, which optionally contains an oxygen atom; or R₁ and R₃, together with the nitrogen atom to which they are attached, form a 4- to 8-membered heterocyclic ring, wherein the heterocyclic ring is a substituted or an unsubstituted ring, which optionally contains an oxygen atom; or R₁, R₂, and R₃, together with the nitrogen atom to which they are attached, form a 4- to 8-membered heteroaromatic ring, wherein the heteroaromatic ring is a substituted or an unsubstituted ring, which optionally contains an oxygen atom; and each R₄ and R₅ is independently alkyl or aryl;
which process comprises reacting sodium borohydride with an amine of formula (II):

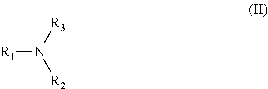

wherein each R₁, R₂, and R₃ is independently selected from hydrogen, alkyl, cycloalkyl, heteroalkyl, heterocycloalkyl, aryl, heteroaryl, alkylaryl, and arylalkyl, wherein each R₁, R₂, and R₃ is an optionally independently substituted with at least one of halo, OH, OR₄, CONR₄R₅, SO₂R₄, alkyl, cycloalkyl, heteroalkyl, heterocycloalkyl, aryl, heteroaryl, alkylaryl, and arylalkyl; or
R₁ and R₂, together with the nitrogen atom to which they are attached, form a 4- to 8-membered heterocyclic ring, wherein the heterocyclic ring is a substituted or an unsubstituted ring, which optionally contains an oxygen atom; or R₁ and R₃, together with the nitrogen atom to which they are attached, form a 4- to 8-membered heterocyclic ring, wherein the heterocyclic ring is a substituted or an unsubstituted ring, which optionally contains an oxygen atom; or R₁, R₂, and R₃, together with the nitrogen atom to which they are attached, form a 4- to 8-membered heteroaromatic ring, wherein the heteroaromatic ring is a substituted or an unsubstituted ring, which optionally contains an oxygen atom; and each R₄ and R₅ is independently alkyl or aryl;
using an activator in the presence of a solvent.

In some embodiments, alkyl is C₁-C₈ alkyl. In some embodiments, cycloalkyl is C₃-C₁₂ cycloalkyl.

In some embodiments, an amine is selected from ammonia (NH₃), methyl amine (NH₂Me), benzylamine (NH₂CH₂Ph), dimethyl amine (NHMe₂), isopropyl amine (NH (i-Pr)₂), trimethyl amine (NMe₃), triethyl amine (NEt₃), piperidine, and cyclohexylamine. In some embodiments, the amine is pyridine, wherein the pyridine is optionally substituted with at least one of alkyl amine and dialkyl amine. In some embodiments, the amine is selected from pyridine, 4-dimethylaminopyridine, 5-ethyl-2-methylpyridine, and 2-picoline.

The solvent can be selected from ethyl acetate, propyl acetate, butyl acetate, ethanol, 2-propanol, aqueous sodium hydroxide, acetone, acetonitrile, and dimethyl sulfoxide. In some embodiments, the solvent is ethyl acetate.

An activator can be an aldehyde of formula R₄—CHO, a ketone of formula R₄—CO—R₅, an alcohol of formula R₄—OH, an organic acid of formula R₄—COOH, a sulfonic acid of formula R₄—SO₃H, or water, wherein each R₄ and R₅ is independently alkyl or aryl. In some embodiments, the activator is selected from acetaldehyde, propanal, acetone, diethyl ketone, ethyl methyl ketone, methanol, ethanol, butanol, phenol, an aliphatic organic acid, an aromatic organic acid, an organic sulfonic acid, and water. In some embodiments, the organic sulfonic acid is methane sulfonic acid, trifluoromethane sulfonic acid, benzene sulfonic acid, or toluene sulfonic acid. In some embodiments, the aliphatic or aromatic organic acid is formic acid, acetic acid, trifluoroacetic acid, or benzoic acid.

In some embodiments, the desired activator is water. Water can be used as a reactant in the presence of a solvent selected from acetates, such as ethyl acetate, propyl acetate, and butyl acetate. It was observed that activators water, methanol, and ethanol did not yield any conversion to the amine-borane in the solvent tetrahydrofuran (THF), but in ethyl acetate, the activators provided reasonable conversion. Of the tested activators, the water activator yielded about 52% (e.g., 52%) conversion in ethyl acetate.

Activation of NaBH₄ by water can produce the monohydroxyborohydride intermediated in situ under ambient conditions (see Scheme 2). Complexation of the amine with borane and displacement of the hydroxy ligand sodium hydroxide (NaOH) provides the corresponding amine-boranes in good yield and purity, even under large-scale processes. Activation of NaBH₄ by water does not occur in THE, the traditional solvent used for amine-borane synthesis, whereas ethyl acetate as a solvent allows for this unique activation due to the reaction heterogeneity.

The reaction can be carried out at an amine concentration in a solvent of about 0.1 M to about 3 M, such as about 0.1 M to 3 M, 0.1 M to about 3 M, or 0.1 M to 3 M. The concentration of the amine-borane complexes used can be between about 0.05 mol/L to about 10 mol/L, such as about 0.05 mol/L to 10 mol/L, 0.05 mol/L to about 10 mol/L or 0.05 mol/L to 10 mol/L. The reaction can be carried out at a temperature from about 0° C. to about 60° C., such as about 0° C. to 60° C., 0° C. to about 60° C., or 0° C. to 60° C. In some embodiments, the desired temperature is room temperature.

Provided is a process for preparing amine-boranes by treating NaBH₄ with an amine and water in the presence of ethyl acetate at room temperature. For example, Scheme 1 illustrates the preparation of an amine-borane, such as 2-picoline-borane.

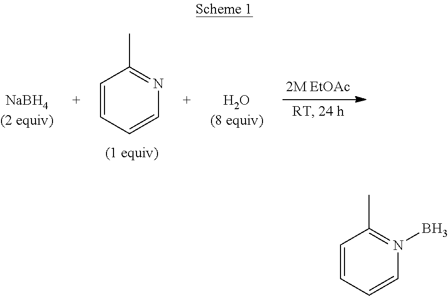

In some embodiments, the amine-borane is a heteroaromatic amine-borane.

The mechanism of amine-borane formation via carbon dioxide (CO₂) reduction by NaBH₄ determined that product formation proceeded by nucleophilic displacement of a ligand. It was proposed that the activators described above can promote the reaction by the same mechanism, with the displaced ligand determined by the activator in each case. The intermediates were formed by either a reduction or dehydrogenation of the activator. The activators e.g., CO₂, ketones, and aldehydes, can be reduced, and water, alcohols, sulfonic acids, carboxylic acids, and boric acid can undergo dehydrogenation.

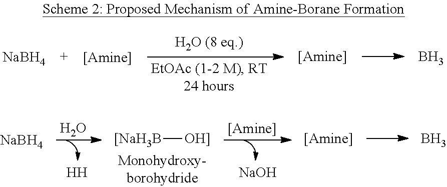

The selected activator, water, can undergo an initial dehydrogenation with NaBH₄ to form a sodium monohydroxyborohydride intermediate. This transient intermediate can readily react and be displaced by the present amine, forming the corresponding amine-borane and an equivalent of sodium hydroxide (Scheme 2), which can act to stabilize NaBH₄.

Table 4 illustrates the optimization of water equivalents.

TABLE 4

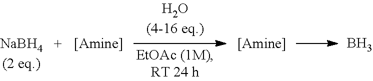

| Entry | Amine | Water (Eq.) | Yield (%)^{a} |
|---|---|---|---|
| 1 | cyclohexylamine | 4 | 71 |
| 2 | cyclohexylamine | 8 | 72 |
| 3 | cyclohexylamine | 16 | 60 |
| 4 | piperidine | 4 | 68 |
| 5 | piperidine | 8 | 78 |
| 6 | piperidine | 16 | 85 |
| 7 | triethylamine | 8 | 85 |
| 8 | triethylamine | 16 | 65 |
| 9^{b} | triethylamine | 16 | 73 |
| 10^{c} | triethylamine | 16 | 30 |

^{a}Isolated yield,
^{b}Performed at 0.5M concentration,
^{c}Reaction used 2.5 eq. of NaBH₄

The equivalency of water needed to promote the reaction most effectively was determined by testing between 4 and 16 equivalents (eq.) of water with cyclohexylamine, piperidine, and triethylamine for the synthesis of the corresponding borane complexes (Table 4). While there was some variability between the examined substrates, 8 eq. of water was determined to be optimal, with yields of 72%, 78%, and 85% obtained for cyclohexylamine-borane, piperidine-borane, and triethylamine-borane, respectively.

The heteroaromatic boranes, such as pyridine borane (PYB), picoline borane (PICB), and 5-ethyl-2-methylpyridine borane (PEMB), were prepared using an optimized procedure of a large scale, with yields of 89%, 87%, and 71%, respectively. The product was isolated using only water.

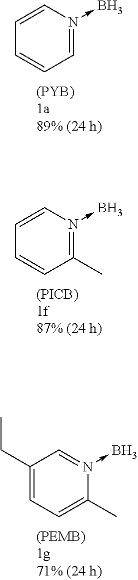

The process can utilize a heterogeneous, dual-solvent system of EtOAc and water, wherein water is an activator for NaBH₄. Activation of NaBH₄ by water can produce the presumed monohydroxyborohydride intermediate in situ under ambient conditions. Displacement of the hydroxy ligand as NaOH by the amine can provide the corresponding amine-boranes in good yield and purity. Activation of NaBH₄ by water further accentuates these latter features. The use of EtOAc makes this process not only environmentally friendly but also economical.

Overall, the present process is economical, environmentally friendly, and advantageous for large-scale reactions due to (i) substitution of traditional solvent THF with EtOAc as a greener solvent, (ii) activation of NaBH₄ by water, (iii) ambient process conditions, and (iv) simple aqueous work-up for the isolation of the products.

The term “substituted” refers to a functional group in which one or more hydrogen atoms contained therein are replaced by one or more non-hydrogen atoms. The term “functional group” or “substituent” refers to a group that can be or is substituted onto a molecule. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo (carbonyl) groups, and carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, azides, hydroxylamines, cyano, nitro groups, N-oxides, hydrazides, and enamines; and other heteroatoms in various other groups.

The term “alkyl” refers to substituted and unsubstituted straight-chain and branched alkyl groups and cycloalkyl groups having from 1 to about 20 carbon atoms (e.g., C₁-C₂₀), 1 to 12 carbons (e.g., C₁-C₁₂), 1 to 8 carbon atoms (e.g., C₁-C₈), or, in some embodiments, from 1 to 6 carbon atoms (e.g., C₁-C₆). Examples of straight-chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “heteroalkyl,” refers to a stable straight-chain or branched or combinations thereof, including at least one carbon atom and at least one heteroatom selected from the group consisting of O, N, P, Si, and S, and wherein the nitrogen and sulfur atoms may optionally be oxidized, and the nitrogen heteroatom may optionally be quaternized. The heteroatom(s) O, N, P, S, B, As, and Si may be placed at any interior position of the heteroalkyl group or at the position at which the alkyl group is attached to the remainder of the molecule. Examples include, but are not limited to: —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, —O—CH₃, —O—CH₂—CH₃, and —CN. Up to two or three heteroatoms may be consecutive, such as, for example, —CH₂—NH—OCH₃ and —CH₂—O—Si(CH₃)₃. A heteroalkyl moiety may include at least one heteroatom (e.g., O, N, S, Si or P).

The term “hydroxyalkyl” as used herein refers to alkyl groups as defined herein substituted with at least one hydroxyl (—OH) group.

The term “cycloalkyl” refers to substituted and unsubstituted cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments, the number of ring carbon atoms range from 3 to 4, 5, 6, or 7. In some embodiments, cycloalkyl groups can have 3 to 6 carbon atoms (e.g., C₃-C₆). Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like.

The term “acyl” refers to a group containing a carbonyl moiety wherein the group is bonded via the carbonyl carbon atom. The carbonyl carbon atom is also bonded to another carbon atom, which can be part of a substituted or unsubstituted alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-40, 6-10, 1-5 or 2-5 additional carbon atoms bonded to the carbonyl group. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” refers to substituted and unsubstituted cyclic aromatic hydrocarbons that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons (e.g., C₆-C₁₄) or from 6 to 10 carbon atoms (e.g., C₆-C₁₀) in the ring portions of the groups. Aryl groups can be unsubstituted or substituted, as defined herein. Representative substituted aryl groups can be mono-substituted or substituted more than once, such as, but not limited to, a phenyl ring substituted with 2-, 3-, 4-, 5-, or 6-substituents or 2-8 substituted naphthyl groups, which can be substituted with carbon or non-carbon groups such as those listed herein.

The term “aralkyl” and “arylalkyl” refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein. The terms “alkaryl” or “alkylaryl” refer to an alkyl group with an aryl substituent.

The term “heterocyclyl” refers to substituted and unsubstituted aromatic and non-aromatic ring compounds containing 3 or more ring members, of which one or more is a heteroatom such as, but not limited to, B, N, O, and S. Thus, a heterocyclyl can be a cycloheteroalkyl, a heteroaryl, or, if polycyclic, any combination thereof. In some embodiments, heterocyclyl groups include 3 to about 20 ring members, whereas other such groups have 3 to about 15 ring members. In some embodiments, heterocyclyl groups include heterocyclyl groups that include 3 to 8 carbon atoms (e.g., C₃-C₈), 3 to 6 carbon atoms (e.g., C₃-C₆) or 6 to 8 carbon atoms (e.g., C₆-C₈).

A heteroaryl ring is an embodiment of a heterocyclyl group. The phrase “heterocyclyl group” includes fused ring species including those that include fused aromatic and non-aromatic groups. Representative heterocyclyl groups include, but are not limited to, pyrrolidinyl, azetidinyl, piperidynyl, piperazinyl, morpholinyl, chromanyl, indolinonyl, isoindolinonyl, furanyl, pyrrolidinyl, pyridinyl, pyrazinyl, pyrimidinyl, triazinyl, thiophenyl, tetrahydrofuranyl, pyrrolyl, oxazolyl, oxadiazolyl, imidazolyl, triazyolyl, tetrazolyl, benzoxazolinyl, benzthiazolinyl, and benzimidazolinyl groups.

The term “heterocyclylalkyl” or “heterocycloalkyl” refers to alkyl groups as defined herein in which a hydrogen or carbon bond of an alkyl group as defined herein is replaced with a bond to a heterocyclyl group as defined herein. Representative heterocyclylalkyl groups include, but are not limited to, furan-2-yl methyl, furan-3-yl methyl, pyridine-3-yl methyl, tetrahydrofuran-2-yl methyl, and indol-2-yl propyl.

The term “heteroarylalkyl” refers to alkyl groups as defined herein in which a hydrogen or carbon bond of an alkyl group is replaced with a bond to a heteroaryl group as defined herein.

The term “alkoxy” refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include, but are not limited to, cyclopropyloxy, cyclobutyloxy, cyclopentyloxy, cyclohexyloxy, and the like. An alkoxy group can further include double or triple bonds and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structure are substituted therewith.

The term “amine” refers to primary, secondary, and tertiary amines having, e.g., the formula N(group)₃ wherein each group can independently be H or non-H, such as alkyl, aryl, and the like. Amines include, but are not limited to, R—NH₂, for example, alkylamines, arylamines, alkylarylamines; R₂NH, wherein each R is independently selected, such as dialkylamines, diarylamines, aralkylamines, heterocyclylamines and the like; and R₃N, wherein each R is independently selected, such as trialkylamines, dialkylarylamines, alkyldiarylamines, triarylamines, and the like. The term “amine” also includes ammonium ions as used herein.

The term “amino group” refers to a substituent of the form-NH₂, —NHR, —NR₂, —NR₃⁺, wherein each R is independently selected, and protonated forms of each, except for-NR₃⁺, which cannot be protonated. Accordingly, any compound substituted with an amino group can be viewed as an amine. An “amino group” can be a primary, secondary, tertiary, or quaternary amino group. An “alkylamino” group includes a monoalkylamino, dialkylamino, and trialkylamino group.

The terms “halo,” “halogen,” and “halide”, by themselves or as part of another substituent, mean, unless otherwise stated, a fluorine, chlorine, bromine, or iodine atom. The term “haloalkyl” group includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, —CF(CH₃)₂ and the like.

The term “optionally substituted” or “optional substituents” means that the groups in question are either unsubstituted or substituted with one or more of the substituents specified. When the groups in question are substituted with more than one substituent, the substituents may be the same or different. The terms “independently,” “independently are,” and “independently selected from” mean that the groups in question may be the same or different. Certain may occur more than once in the structure, and upon such occurrence, each term shall be defined independently of the other.

The compounds may contain one or more chiral centers or may otherwise be capable of existing as multiple stereoisomers. It is to be understood that the invention described herein is not limited to any particular stereochemical requirement, and that the compounds may be optically pure or may be any of a variety of stereoisomeric mixtures, including racemic and other mixtures of enantiomers, other mixtures of diastereomers, and the like. It is also to be understood that such mixtures of stereoisomers may include a single stereochemical configuration at one or more chiral centers, while including mixtures of stereochemical configuration at one or more other chiral centers.

Similarly, the compounds described herein may include geometric centers, such as cis, trans, E, and Z double bonds. It is to be understood that the invention described herein is not limited to any particular geometric isomer requirement, and that the compounds may be pure, or may be any of a variety of geometric isomer mixtures. It is also to be understood that such mixtures of geometric isomers may include a single configuration at one or more double bonds, while including mixtures of geometry at one or more other double bonds.

### EXPERIMENTAL

The following examples serve to illustrate the present disclosure. The examples are not intended to limit the scope of the claimed invention in any way.

### Optimization of the Process of Preparing Amine-Borane

Initial optimization was carried out using a series of low molecular weight aldehydes, ketones, and alcohols as activators and representative primary (1°), secondary (2°), tertiary) (3°, and heteroaromatic amines. The reactions were performed using an equimolar stoichiometry of NaBH₄, activator, and amine in tetrahydrofuran (0.3 M). The summarized results (Table 1) show that the reactions using aldehydes are typically complete within 1 hour, while ketones and alcohols require much longer (≥20 hours) reaction times. The yields (37%-78%) observed when using aldehyde activation compared to ketones or alcohols (5%-60%) were also superior. Other factors studied at this stage were reaction concentration and temperature. The conversion of dimethylaminopyridine (DMAP) to the corresponding amine-borane was performed at 0.5 M and 2 M concentrations, with minimal deviation from the 37% yield observed for the 0.3 M reaction. Lowering the reaction temperatures to about 0° C., also had negligible effect on the overall conversion. Propanal was chosen as the model activator due to its low acute toxicity compared to acetaldehyde, as both are inexpensive due to their high annual production levels. The low boiling point of acetaldehyde was also seen as a distinct disadvantage for handling. A reaction concentration of 2 M and ambient temperature were selected to minimize the solvent quantity and for operational convenience.

TABLE 1
Initial scan of NaBH₄ activators.

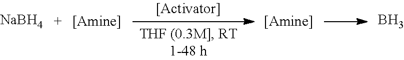

| Entry | Amine | Activator | Time (h) | Yield (%) |
|---|---|---|---|---|
| 1 | allylamine | acetaldehyde | 1 | 55 |
| 2 | piperidine | acetaldehyde | 1 | 78 |
| 3 | piperidine | acetone | 20 | 60 |
| 4 | triethylamine | acetaldehyde | 1 | 69 |
| 5 | triethylamine | propanal | 1 | 72 |
| 6 | triethylamine | methanol | 48 | 5 |
| 7 | triethylamine | ethanol | 20 | 13 |
| 8 | DMAP | propanal | 20 | 37 |

The inescapable necessity of solvents in chemical synthesis and their utilization on the scale of tens of millions of tons annually have prompted a transition to solvents with greater adherence to the green chemistry principles. There have been numerous solvent selection guides and surveys of those guides published recently with the aim of steering chemists towards “greener” solvents, allowing consideration of chemical functionality, physical properties, regulatory concerns, and safety/health/environmental (SHE) impact. One such survey (Green Chem. 2014, 16, 4546-4551), of Pfizer, GSK, and Sanofi solvent selection guides, was used as the basis for establishing the classification of the solvents that were selected for investigation. Based on the classification criteria, tetrahydrofuran, the solvent ubiquitous throughout amine-borane synthesis protocols, is listed as class 4, between problematic and hazardous. The other solvents studied were chosen due to their lower classifications. Ethanol (EtOH), isopropanol (iPrOH), 0.1 M NaOH (aq), and ethyl acetate (EtOAc) are recommended, class 1, acetone is between recommended and problematic, class 2, and acetonitrile (MeCN) and dimethyl sulfoxide (DMSO) are problematic, class 3. A summary of the selected solvents and their classifications is shown in Table 2.

TABLE 2
DMAP-BH₃ synthesis solvent study

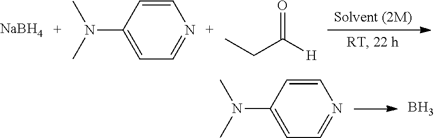

| | | Solvent | Conversion^{b} |
|---|---|---|---|
| Entry | Solvent | Class^{a} | DMAP-BH₃:DMAP |
| 1 | THF | 4 | 35:65 |
| 2 | EtOH | 1 | 3:97 |
| 3 | iPrOH | 1 | 9:91 |
| 4 | NaOH^{c} | 1 | 0:100 |
| 5 | EtOAc | 1 | 27:73 |
| 6 | EtOAc^{d} | 1 | 33:67 |
| 7 | Acetone | 2 | 20:80 |
| 8 | MeCN | 3 | 9:91 |
| 9 | DMSO | 3 | 28:72 |

^{a}(1) recommended, (2) between recommended and problematic, (3) problematic, (4) between problematic and hazardous, (5) hazardous, (6) highly hazardous;
^{b}conversion determined by ¹H NMR;
^{c}added as a 0.1M aqueous solution,
^{d}1M with respect to propanal.

The reactions for the solvent study were performed using an equimolar stoichiometry of NaBH₄, activator (propanal), and amine (DMAP) in each solvent at a 2 M concentration. DMAP was selected as the model amine due to its high boiling point, allowing for straightforward determination of the conversion from amine to amine-borane by 1H NMR spectroscopic analysis. Taking THE as the baseline case against which the other solvents would be compared, a conversion of 35% of DMAP to the corresponding borane complex was determined. The class 1 protic solvents gave very poor (<10%) or no conversion. EtOAc gave 27% and 33% conversion at 2 M and 1 M concentrations, respectively. The class 2 solvent, acetone, produced a 20% conversion, however, a reddening of the reaction solution indicated a self-condensation reaction of the solvent. The class 3 solvent MeCN gave a poor conversion of 9%, and while DMSO gave 28% conversion, removal of the residual solvent proved to be very difficult. Based on these results, EtOAc was selected as the reaction solvent. Its product conversion compared favorably with THE, it is also a “greener” solvent, and is less expensive than THF.

The next stage of the optimization was the investigation of a wide range of potential activators of NaBH₄. The reactions were performed using an equimolar stoichiometry of NaBH₄, activator, and amine (DMAP) in either THF or EtOAc at a 2 M concentration at RT for 22 hours. The activators studies, summarized in Table 3, included CO₂ (Table 3, Entry 1), ketones (Entries 2-3), aldehydes (Entries 4-7), water and alcohols (Entries 8-11), sulfonic acids (Entries 12-13), carboxylic acids (Entries 14-17), and boric acid (Entry 18). The conversion listed in Table 3, Entry 1 for THE is reported for CO₂-mediated amine-borane synthesis (U.S. Pat. No. 9,834,448), the conversion value obtained after switching the solvent to EtOAc was 61%. The ketones evaluated were found to react slowly in both solvents tested, achieving conversion of between 5% and 26%. When assessing the aldehydes, it was found that more sterically hindered aldehydes provided a higher conversion to the amine-borane, with pivaldehyde yielding 54% and 52% conversion in THF and EtOAc, respectively. The most interesting results were obtained when testing water and alcohol as activators. While phenol produced 30% and 36% conversion, water, methanol, and ethanol did not yield any conversion to the amine-borane in THE, but EtOAc gave modest to respectable conversion, with water activation yielding 52% conversion. Of the tested sulfonic and carboxylic acids toluenesulfonic acid gave 82% and 46% conversion in THF and EtOAc, respectively, but the remainder of the tested acids provided a maximum of 39% in either solvent. Of the tested activators, water gave the highest conversion in EtOAc, apart from CO₂. Due to the convenience of the addition of liquid versus gaseous reagents, the very low cost, and being the “greenest” of the tested reagents, water was selected as the activator for the reaction.

TABLE 3
Study of activators for DMAP-BH₃ synthesis

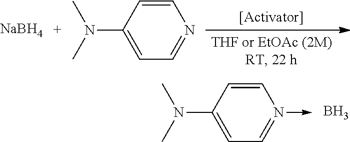

| | | ¹H NMR Conversion^{a} | |
|---|---|---|---|
| | | DMAP-BH₃:DMAP | |
| Entry | Activator | THF | EtOAc |
| 1 | carbon dioxide | 99:1^{b} | 61:39 |
| 2 | acetone | 26:74 | 10:90 |
| 3 | butanone | 19:81 | 5:95 |
| 4 | acetaldehyde | 35:65 | 31:69 |
| 5 | propionaldehyde | 35:65 | 33:67 |
| 6 | isobutyraldehyde | 46:54 | 44:56 |
| 7 | pivaldehyde | 54:46 | 52:48 |
| 8 | water | 0:100 | 52:48 |
| 9 | methanol | 0:100 | 26:74 |
| 10 | ethanol | 0:100 | 10:90 |
| 11 | phenol | 30:70 | 36:64 |
| 12 | toluenesulfonic Acid | 82:18 | 46:54 |
| 13 | methanesulfonic Acid | 2:98 | — |
| 14 | trifluoroacetic Acid | 5:95 | 30:70 |
| 15 | formic acid | 31:69 | 39:61 |
| 16 | benzoic Acid | 33:67 | 39:61 |
| 17 | acetic Acid | 14:86 | 37:63 |
| 18 | boric Acid | 14:86 | — |

^{a}Conversion determined by ¹H NMR,
^{b}Value is reported for NaBH₄ (2 eq.) activation by CO₂ in Dalton Trans. 2021, 50, 16770-16774.

### Optimization Examples

### Preparation of Amine-Boranes at 2 Mmol Scale

Using the optimized reaction conditions (2 eq. NaBH₄, 8 eq. H₂O, and 1 eq. amine, in 1 M EtOAc at RT), a selected series of amine-boranes were prepared. Representative 1° amine, e.g., cyclohexylamine, 2° amine, e.g., piperidine and N-methylbenzylamine, 3°amine, e.g., triethylamine, and heteroaromatic amine, e.g., pyridine amines were each examined. The corresponding amine-boranes (1a-1e) were obtained in each case in 72% to 97% yields within 24 hours. The reaction to produce N-methylbenzylamine (1d) was left to stir for 72 hours to test for product decomposition over a longer reaction duration, but no decomposition was observed, and the product was isolated in 97% yield.

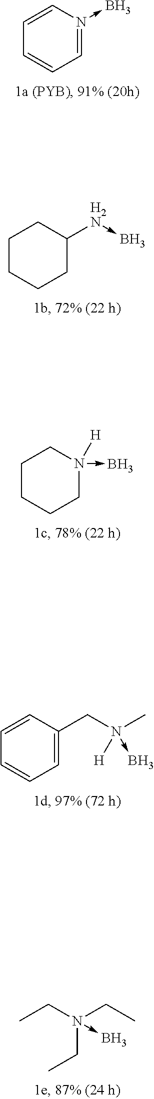

### Preparation of Amine-Boranes at 100 Mmol Scale.

Heteroaromatic adducts, e.g., pyridine-borane (PYB), 2-picoline borane (PICB), 5 and-ethyl-2-methylpyridine borane (PEMB) were synthesized on high scale of 100 mmol scale. The 100 mmol scale reaction was performed using the optimized procedure, with all steps at RT. NaBH₄ (7.57 g) was added to the empty 250 mL reaction flask, followed by 100 mL of EtOAc, and the respective amine for each individual reaction (pyridine (8.1 mL), 2-picoline (9.8 mL), and 5-ethyl-2-methylpyridine (13.2 mL)). Water (14.4 mL) was added to each reaction in 1 mL portions with vigorous stirring using a magnetic stir plate and stir bar. During the water addition, only very mild hydrogen generation was observed, and it was found that the water could be added in a single portion without causing an overreaction. There was additionally no noticeable increase in the reaction temperature during or after water addition. After each reaction was stirred for 24 hours at RT, they were examined by ¹¹B NMR spectroscopy for the absence of NaBH₄ and then subjected to an aqueous work-up. Residual pyridine and 2-picoline were washed out in the aqueous phase due to their miscibility. The low water solubility of 5-ethyl-2-methylpyridine, however, necessitated an additional wash using a citric acid solution to remove residual amine. It was also found that the neat PEMB product liquid could be extracted using hexanes to remove residual amine. After complete solvent removal, PYB (1a), PICB (1f), and PEMB (1g) were obtained in 89%, 87%, and 71% yields, respectively.

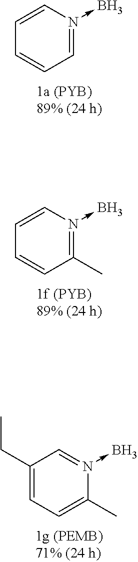

### Pyridine-Boranes Prepared at 100 Mmol Scale

### Preparation of Pyridine-Borane at 1.1 Mole Scale.

An additional scale up reaction was performed for PYB at 1.1 mole (˜100 g) scale. Following the optimized procedure, only minor modifications were made. Using a three-necked flask, one neck was fitted with a thermometer, and a second neck was connected to an analytical gas buret. NaBH₄ (2.2 mole, 84.4 g) was added, followed by 550 mL of EtOAc for a concentration of 2 M with respect to the amine, reduced from the earlier 1 M concentration. Pyridine (1.1 mole, 90 mL) was added, then, with vigorous stirring using a magnetic stir plate and sufficiently large stir bar, water (8.8 mole, 158 mL) was added in three approximately 50 mL portions, and the vessel sealed. Gas output and temperature changes were monitored very closely for the first 3 hours of the reaction. Though the bubbling of the reaction was not vigorous, even immediately after water addition, the reaction did put out ˜3.6 liters of gas (presumedly H₂) in this time. Due to the quantity of H₂ evolved from the reaction, proper precautions were taken to avoid accumulation or equipment pressurization. The submerged thermometer indicated a slight rise in temperature over this time period, from 25° C. to 27° C., although heat from the stir plate may play a role in this rise. The stirring throughout the reaction must remain vigorous, however, as the mixture is heterogenous and will separate into two layers if left unstirred. The NaBH₄ is largely insoluble in EtOAc, but dissolved in the added water, which was mixed with the organic layer. It was also found that mechanical stirring will produce comparable results (described later). The reaction was monitored by ¹¹B NMR for consumption of NaBH₄. It can also be monitored by 1H NMR, checking for the disappearance of pyridine, as well as by TLC. Using a 30:70 hexanes: EtOAc solvent system, good separation was achieved, with PYB rising to an Rf of 0.53 and pyridine an Rf of 0.25. Although pyridine is the limiting reagent, it was observed that NaBH₄ consumed first, leaving some unreacted pyridine.

The work-up process was modified by using only water to transfer the reaction mixture into the separatory funnel. The reaction mixture consists of the product PYB, residual pyridine, and a solid white precipitate, along with water and EtOAc. The residual pyridine was washed out of the mixture into the aqueous fractions. During the examination of the aqueous fractions by ¹¹B NMR, the white solid determined, most likely, to be sodium tetrahydroxyborate [NaB(OH)₄] (δ 2.32 ppm), was also found to be present formed from the complete hydrolysis of a portion of NaBH₄. A minor amount of product PYB (1a) was also detected, though increasingly smaller quantities were detected in the later wash fractions. Upon drying and removal of the solvent, the reaction was found to have provided 77.65 g (75.6%) of pyridine-borane (1a). A 100 mmol scale reaction also performed at 2 M concentration gave an 80% yield of PYB, slightly lower than the 89% yield obtained at 1 M concentration. The slight decrease in yield may be due to difficulty in stirring the reaction mixture at the increased reaction concentration. This was examined by repeating the 1.1 mole scale PYB (1a) synthesis using mechanical stirring, where 89.7 g (87.7%) of 1a was recovered. The increase in yield when using mechanical stirring demonstrates that the yield obtained at the 100 mmol scale can be reproduced at >1 mole scale with reasonable fidelity, even when increasing the concentration to 2 M.

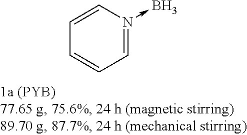

### Pyridine-Borane Prepared at 1.1 Mole Scale

The product obtained by magnetic stirring (1a) was examined for purity using quantitative 1H NMR. Using 1,3,5-trioxane as a standard, the peaks at δ 5.15 ppm from trioxane and δ 8.61 ppm from PYB, a purity of 96.3% was determined. Much of the impurity was the result of residual EtOAc, which was still slightly visible in the 1H NMR spectrum.

### EXAMPLES

### General Information:

All amines, activators, and sodium borohydride were purchased from Sigma-Aldrich and/or Oakwood Chemical and solvents purchased from Fisher Scientific.

Thin-layer chromatography (TLC) was performed on silica gel F60 plates and visualized under UV light. The product purities were confirmed by nuclear magnetic resonance (NMR) spectroscopy and chemical shifts measured in 8 values in parts per million (ppm). 1H NMR spectra were recorded from a Varian 300 MHz spectrometer at ambient temperature and calibrated against the residual solvent peak of CDCl3 (δ=7.26 ppm) as an internal standard. The ¹³C NMR spectra were recorded at 75 MHz and calibrated using CDCl3 (δ=77.36 ppm) as an internal standard. ¹¹B NMR spectra were recorded at 96 MHz, and chemical shifts were reported relative to the external standard, BF₃/diethyl ether (Et₂O) (δ=0 ppm). Coupling constants (J) are given in hertz (Hz), and signal multiplicities are described of NMR data as: s=singlet, d=doublet, t=triplet, dd=double doublet, dt=double triplet, q=quartet, p=pentet, m=multiplet, and br=broad.

A] General Procedure for the Synthesis of Amine-Borane (2 Mmol Scale, from NaBH₄, Water, and Amine):

To a 3-gram vial containing a stir bar was added sodium borohydride (1 eq., 0.002 mole, 0.075 g), followed by, under stirring, 1 mL of solvent, and the amine (1 eq., 0.002 mole) in one portion, or via syringe if a liquid. Subsequently, with very vigorous stirring, the activator (1-16 eq.) was added in portions, or dropwise via syringe. The reaction mixture was allowed to stir for 22-24 h, then the contents of the flask were transferred to a separatory funnel using 20 mL of ethyl acetate and 10 mL water. The mixture was shaken, and the water was separated. The organic layer was washed with an additional 2×10 mL portions of water, then 10 mL of brine, and dried over sodium sulfate. The mixture was filtered through cotton and condensed via rotary evaporation. The resulting material was transferred to a vial and further dried under high vacuum, to yield the amine-borane.

### Example 1

Amine-Borane (2 mmol Scale)

To a 3-g vial containing a stir bar was added sodium borohydride (2 eq., 0.004 mole, 0.1492 g), followed by 2 mL of ethyl acetate (1 M with respect to amine). Then, with stirring, amine (1 eq., 0.002 mole) was added via syringe. Then, with very vigorous stirring, water (8 eq., 0.016 mole, 0.29 mL) was added dropwise via syringe. The reaction mixture was checked by ¹¹B NMR for consumption of borohydride, and after reaction completion, the contents of the flask were transferred to a separatory funnel using 20 mL of ethyl acetate and 10 mL water. The mixture was shaken, and the water removed. The ethyl acetate layer was washed with an additional 2×10 mL portions of water, then 10 mL of brine, and dried over sodium sulfate. The organic fractions were filtered through cotton and condensed via rotary evaporation. The resulting material was transferred to a vial and further dried under a high vacuum overnight.

### Example 2

Pyridine-borane (1a) (2 mmol): The compound was prepared as described in procedure A (2 mmol scale) and obtained as a colorless liquid (mass=170 mg, 91% yield).

¹H NMR (300 MHz, CDCl₃) δ 8.65-8.48 (m, 2H), 8.01-7.86 (m, 1H), 7.60-7.42 (m, 2H), 3.15-2.04 (m, 3H). ¹³C {H} NMR (75 MHz, CDCl₃) δ 147.2, 139.3, 125.4. ¹¹B NMR (96 MHz, CDCl₃) δ−12.59 (q, J=97.4 Hz, 3H). Compound characterization is in accordance with previous reports (Ramachandran, P. V. et al., Dalton Transaction, 2021, 50, 16770-16774).

### Example 3

Cyclohexylamine-borane (1b): The compound was prepared as described in procedure A (2 mmol scale) and obtained as a white solid (mass=162 mg, 72% yield).

¹H NMR (300 MHz, CDCl₃) δ 3.65 (s, 2H), 2.68 (ttt, J=10.2, 6.4, 3.8 Hz, 1H), 2.12 (dt, J=12.4, 3.7 Hz, 2H), 1.75 (dq, J=12.3, 3.7, 3.2 Hz, 2H), 1.62 (dt, J=12.3, 3.7 Hz, 1H), 1.37-1.08 (m, 5H). ¹³C {H} NMR (75 MHZ, CDCl₃) δ 57.3, 32.6, 25.6, 24.9. ¹¹B NMR (96 MHz, CDCl₃) δ-20.92 (q, J=96.5, 95.8 Hz). Compound characterization is in accordance with previous reports (Ramachandran, P. V. et al., Dalton Transaction, 2021, 50, 16770-16774).

### Example 4

Piperidine-borane (1c): The compound was prepared as described in procedure A (2 mmol scale) and obtained as a white solid (mass=155 mg, 78% yield).

¹H NMR (300 MHz, CDCl₃) δ 3.75 (s, 1H), 3.30-3.13 (m, 2H), 2.59-2.36 (m, 2H), 1.82-1.68 (m, 3H), 1.51 (tdd, J=13.4, 10.9, 3.7 Hz, 2H), 1.31 (dddd, J=16.1, 12.4, 8.6, 4.2 Hz, 1H). ¹³C {H} NMR (75 MHz, CDCl₃) δ 53.6, 25.6, 22.8. ¹¹B NMR (96 MHz, CDCl₃) δ−15.55 (q, J=95.5 Hz). Compound characterization is in accordance with previous reports (Ramachandran, P. V. et al., Dalton Transaction, 2021, 50, 16770-16774).

### Example 5

N-Methylbenzylamine-borane (1d): The compound was prepared as described in procedure A (2 mmol scale) and obtained as a white solid (mass=262 mg, 97% yield).

¹H NMR (300 MHz, CDCl₃) δ 7.51-7.19 (m, 5H), 4.28 (dd, J=13.9, 2.8 Hz, 2H), 3.56-3.43 (m, 1H), 2.40 (d, J=5.8 Hz, 3H). ¹³C {H} NMR (75 MHZ, CDCl₃) δ 134.2, 129.6, 129.1, 128.9, 61.0, 40.4. ¹¹B NMR (96 MHz, CDCl₃) δ−14.20 (q, J=97.9 Hz). Compound characterization is in accordance with previous reports (Ramachandran, P. V. et al., Dalton Transaction, 2021, 50, 16770-16774).

### Example 6

Triethylamine-borane (1e): The compound was prepared as described in procedure A (2 mmol scale) and obtained as a colorless liquid (mass=200 mg, 87% yield).

¹H NMR (300 MHz, CDCl₃) δ 2.61 (q, J=7.3 Hz, 6H), 1.02 (t, J=7.3 Hz, 9H). ¹³C {H} NMR (75 MHz, CDCl₃) δ 52.3, 8.6. ¹¹B NMR (96 MHz, CDCl₃) δ−13.81 (q, J=97.2, 96.8 Hz). Compound characterization is in accordance with previous reports (Ramachandran, P. V. et al., Dalton Transaction, 2021, 50, 16770-16774).

B] General Procedure for the Synthesis of Amine-Boranes (100 Mmol Scale, from NaBH₄, Water, and Amine)

To a 200 mL round bottom flask containing a stir bar was added sodium borohydride (2 eq., 0.2 mole, 7.566 g), followed by 100 mL of ethyl acetate (1 M with respect to amine). Then, with stirring, pyridine (1 eq., 0.1 mole, 8.05 mL) was added via syringe. Then, with very vigorous stirring, water was added in three 5 mL portions. The reaction mixture was checked by ¹¹B NMR at 2 hours and 20 hours, where 50% and 99% of the borohydride had been consumed, respectively. After reaction completion at 20 hours, the contents of the flask were transferred to a 500 mL separatory funnel using 100 mL of ethyl acetate and 50 mL water. The mixture was shaken, and the water was removed. The ethyl acetate layer was washed with an additional 2×50 mL portions of water, 50 mL of 1 M citric acid (aq) in the case of 5-ethyl-2-methylpyridine, then 50 mL of brine, and dried over sodium sulfate. The mixture was filtered through cotton and condensed via rotary evaporation. After condensing some small particulates were observed. The liquid was passed through a small bit of celite in a cotton-plugged pipette, and a small (˜5 mL) portion of dichloromethane was used to complete the transfer and wash the pipette. The resulting liquid was stirred under a high vacuum and provided the product.

### Example 7

Pyridine-borane (1a) (100 mmol): The compound was prepared as described in procedure B (100 mmol scale) and obtained as a colorless liquid (mass=8.28 g, 89% yield). The reaction was monitored by ¹¹B NMR for consumption of NaBH₄. It can also be monitored by 1H NMR, checking for the disappearance of pyridine, as well as by TLC. Using a 30:70 hexanes: EtOAc solvent system, good separation was achieved, with pyridine-borane rising to an Rf of 0.53 and pyridine an Rf of 0.25. Although pyridine is the limiting reagent, it was observed that NaBH₄ is consumed first, leaving some unreacted pyridine.

¹H NMR (300 MHz, CDCl₃) δ 8.65-8.48 (m, 2H), 8.01-7.86 (m, 1H), 7.60-7.42 (m, 2H), 3.15-2.04 (m, 3H). ¹³C {H} NMR (75 MHz, CDCl₃) δ 147.1, 139.3, 125.5. ¹¹B NMR (96 MHz, CDCl₃) δ−12.56 (q, J=97.4 Hz). Compound characterization is in accordance with previous reports (Ramachandran, P. V. et al., Dalton Transaction, 2021, 50, 16770-16774).

### Example 8

2-Picoline-borane (1f): The compound was prepared as described in procedure B (100 mmol scale) and obtained as a white solid (mass=9.29 g, 87% yield).

¹H NMR (300 MHz, CDCl₃) δ 8.64 (d, J=6.0 Hz, 1H), 7.78 (td, J=7.8, 1.6 Hz, 1H), 7.34 (d, J=7.8 Hz, 1H), 7.31-7.19 (m, 1H), 2.67 (s, 3H), δ 2.42 (dd, J=188.9, 89.9 Hz, 3H). ¹³C {H} NMR (75 MHz, CDCl₃) δ 157.6, 148.6, 139.7, 126.9, 122.6, 22.8. ¹¹B NMR (96 MHz, CDCl₃) δ−14.23 (q, J=97.3 Hz). Compound characterization is in accordance with previous reports (Ramachandran, P. V. et al., Dalton Transaction, 2021, 50, 16770-16774).

### Example 9

5-Ethyl-2-methylpyridine-borane (1g): The compound was prepared as described in procedure B (100 mmol scale) and obtained as a colorless liquid (mass=9.60 g, 71% yield)

¹H NMR (300 MHz, CDCl₃) δ 8.59-8.40 (m, 1H), 7.61 (dd, J=8.0, 2.2 Hz, 1H), 7.24 (d, J=8.0 Hz, 1H), 2.63 (s, 3H), 2.60 (q, J=7.6 Hz, 2H), 1.19 (t, J=7.6 Hz, 3H). ¹³C {H} NMR (75 MHZ, CDCl₃) δ 154.6, 147.8, 139.1, 138.5, 126.5, 25.6, 22.1, 15.0. ¹¹B NMR (96 MHz, CDCl₃) δ−14.36 (q, J=97.4 Hz). Compound characterization is in accordance with previous reports (Burkhardt, E. R et al., Tetrahedron Lett. 2008, 49, 5152-5155).

C] General Procedure for the Synthesis of Pyridine-Borane (1.1 Mole Scale, from NaBH₄, Water, and Pyridine)

A 2 L 3 necked round bottom flask containing a stir bar was equipped with an adaptor holding a thermometer and barbed hose adaptor connected to an analytical gas burette. Through the remaining open neck was added sodium borohydride (2 eq., 2.2 mole, 84.4 g), followed by 550 mL of ethyl acetate (2 M with respect to amine). With stirring, pyridine (1 eq., 1.1 mole, 90 mL) was added, and the remaining neck was closed with a reducing adaptor and rubber septum. Water (8 eq., 8.8 mole, 158 mL) was added with very vigorous stirring, in three ˜50 mL portions. The reaction temperature and gas output were closely monitored for the first 3 hours of the reaction. After 23 hours, the contents of the reaction flask had become primarily a solid that was unable to be stirred. A TLC (30:70, hexanes:ethyl acetate) showed the presence of a small amount of remaining pyridine, but ¹¹B NMR spectrum of the reaction mixture showed no sodium borohydride present. A 0.5 L portion of water was added to the reaction flask, and the contents transferred to a 2 L separatory funnel using an additional 250 ml of water. After separation, the water was removed. The ethyl acetate layer was washed with an additional 2×250 mL portions of water, then 250 mL of brine, and dried over sodium sulfate. The mixture was filtered through cotton and condensed via rotary evaporation. The resulting liquid was stirred under high vacuum overnight. An initial ¹H NMR of the resulting product still showed the presence of ethyl acetate. The mixture was placed under high vacuum and sonicated using a 40 kHz bath sonicator for 5 minutes, followed by 5 minutes of stirring, 3 such intervals were performed, and then 5 mL of dichloromethane was added to the mixture. The resulting liquid was stirred under a high vacuum overnight, providing pyridine-borane (77.65 g, 75.6%). A synthesis replacing magnetic stirring with mechanical stirring provided 89.7 g (87.7%) of pyridine-borane.

### Example 10

Pyridine-borane (1a) (1.1 mole): The compound was prepared as described in procedure C (1.1 mole scale) and obtained as a colorless liquid (magnetic stirring: mass=77.65 g, 75.6% yield; mechanical stirring: mass=89.7 g, 87.7% yield).

¹H NMR (300 MHz, CDCl₃) δ 8.58 (d, J=4.9 Hz, 2H), 8.04-7.82 (m, 1H), 7.60-7.44 (m, 2H), 3.13-2.03 (m, 3H). ¹³C {H} NMR (75 MHz, CDCl₃) δ 147.0, 139.2, 125.4. ¹¹B NMR (96 MHZ, CDCl3) δ−12.56 (q, J=97.5 Hz). Compound characterization is in accordance with previous reports (Ramachandran, P. V. et al., Dalton Transaction, 2021, 50, 16770-16774).

The term “about” can allow for a degree of variability in a value or range, for example, within 10%, within 5%, or within 1% of a stated value or of a stated limit of a range. In the present disclosure the term “substantially” can allow for a degree of variability in a value or range, for example, within 90%, within 95%, 99%, 99.5%, 99.9%, 99.99%, or at least about 99.999% or more of a stated value or of a stated limit of a range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

We claim:

1. A process for preparing an amine-borane of formula (I): 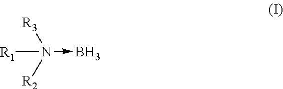
wherein each R₁, R₂, and R₃ is independently selected from hydrogen, alkyl, cycloalkyl, heteroalkyl, heterocycloalkyl, aryl, heteroaryl, alkylaryl, and arylalkyl, wherein each R₁, R₂, and R₃ is optionally independently substituted with at least one of halo, OH, OR₄, CONR₄R₅, SO₂R₄, alkyl, cycloalkyl, heteroalkyl, heterocycloalkyl, aryl, heteroaryl, alkylaryl, and arylalkyl; or
R₁ and R₂, together with the nitrogen atom to which they are attached, form a 4- to 8-membered heterocyclic ring, wherein the heterocyclic ring is a substituted or an unsubstituted ring, which optionally contains an oxygen atom; or R₁ and R₃, together with the nitrogen atom to which they are attached, form a 4- to 8-membered heterocyclic ring, wherein the heterocyclic ring is a substituted or an unsubstituted ring, which optionally contains an oxygen atom; or R₁, R₂, and R₃, together with the nitrogen atom to which they are attached, form a 4- to 8-membered heteroaromatic ring, wherein the heteroaromatic ring is a substituted or unsubstituted ring, which optionally contains an oxygen atom; and each R₄ and R₅ is independently alkyl or aryl;
which process comprises reacting sodium borohydride with an amine of formula (II): 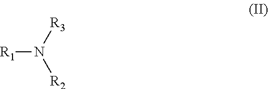
wherein each R₁, R₂, and R₃ is independently selected from hydrogen, alkyl, cycloalkyl, heteroalkyl, heterocycloalkyl, aryl, heteroaryl, alkylaryl, and arylalkyl, wherein each R₁, R₂, and R₃ is optionally independently substituted with at least one of halo, OH, OR₄, CONR₄R₅, SO₂R₄, alkyl, cycloalkyl, heteroalkyl, heterocycloalkyl, aryl, heteroaryl, alkylaryl, and arylalkyl; or
R₁ and R₂, together with the nitrogen atom to which they are attached, form a 4- to 8-membered heterocyclic ring, wherein the heterocyclic ring is a substituted or an unsubstituted ring, which optionally contains an oxygen atom; or R₁ and R₃, together with the nitrogen atom to which they are attached, form a 4- to 8-membered heterocyclic ring, wherein the heterocyclic ring is a substituted or an unsubstituted ring, which optionally contains an oxygen atom; or R₁, R₂, and R₃, together with the nitrogen atom to which they are attached, form a 4- to 8-membered heteroaromatic ring, wherein the heteroaromatic ring is a substituted or unsubstituted ring, which optionally contains an oxygen atom; and each R₄ and R₅ is independently alkyl or aryl;
using an activator in the presence of a solvent.

2. The process in claim 1, wherein the amine is selected from ammonia (NH₃), methyl amine (NH₂Me), benzylamine (NH₂CH₂Ph), dimethyl amine (NHMe₂), isopropyl amine (NH (i-Pr)₂), trimethyl amine (NMe₃), triethyl amine (NEt₃), piperidine, and cyclohexylamine.

3. The process of claim 1, wherein the amine is pyridine, wherein the pyridine is optionally substituted with at least one of alkyl amine or dialkyl amine.

4. The process of claim 3, wherein the substituted pyridine is 4-dimethylaminopyridine, 5-ethyl-2-methylpyridine, or 2-picoline.

5. The process in claim 1, wherein the solvent is selected from ethyl acetate, propyl acetate, butyl acetate, ethanol, 2-propanol, aqueous sodium hydroxide, acetone, acetonitrile, and dimethyl sulfoxide.

6. The process in claim 1, wherein the activator is selected from an aldehyde of formula R₄—CHO, a ketone of formula R₄—CO—R₅, an alcohol of formula R₄—OH, an organic acid of formula R₄—COOH, a sulfonic acid of formula R₄—SO₃H, and water, wherein each R₄ and R₅ is independently alkyl or aryl.

7. The process in claim 6, wherein the activator is water.

8. The process in claim 6, wherein the activator is selected from acetaldehyde, propanal, acetone, diethyl ketone, ethyl methyl ketone, methanol, ethanol, butanol, phenol, formic acid, acetic acid, trifluoroacetic acid, benzoic acid, methane sulfonic acid, trifluoromethane sulfonic acid, benzene sulfonic acid, and toluene sulfonic acid.

9. The process in claim 1, wherein the process is carried out at a concentration of the amine in the solvent of about 0.1 M to about 3 M.

10. The process in claim 1, wherein the amine-borane is obtained in a concentration of about 0.05 mol/L to about 10 mol/L.

11. The process in claim 1, wherein the process can be carried out at a temperature from about 0° C. to about 60° C.
